(19) United States
(12) Patent Application Publication
(10) Pub. No.: US 2015/0285698 A1
(43) Pub. Date: Oct. 8, 2015

(54) PRESSURE DISTRIBUTION SENSOR, METHOD OF MEASURING PRESSURE DISTRIBUTION, AND ROBOT HAND

(71) Applicant: SEIKO EPSON CORPORATION, Tokyo (JP)

(72) Inventor: Tetsuro MATSUMOTO, Chino-shi (JP)

(21) Appl. No.: 14/669,846

(22) Filed: Mar. 26, 2015

(30) Foreign Application Priority Data
Apr. 3, 2014 (JP) 2014-076834

(51) Int. Cl. G01L 5/18; B25J 15/02; B25J 9/16; B25J 19/02

(52) U.S. Cl. CPC G01L 5/18; B25J 19/02; B25J 15/0253; B25J 9/1612

(57) ABSTRACT

A pressure distribution sensor includes a sensor element having plurality of current-driven actuator segments each having a first electrode and second electrode arranged in a first direction and a second direction different from the first direction, and a corresponding number of sensing circuits to the number of the actuator segments. The sensing circuits each include a first terminal electrically connected to the first electrode, a second terminal electrically connected to the second electrode, a third terminal to which an electrode selection signal for selecting one of the first electrode and the second electrode is input, a fourth terminal to which a segment selection signal for selecting the actuator segment out of the plurality of actuator segments is input, and a fifth terminal adapted to output a signal obtained via the electrode selected by the electrode selection signal from the electrodes of the actuator segment selected by the segment selection signal.

This application claims a priority to Japanese Patent Application No. 2014-076834 filed on Apr. 3, 2014 which is hereby expressly incorporated by reference in its entirety.

### BACKGROUND

1. Technical Field

Several aspects of the present invention relate to a pressure distribution sensor, a method of measuring a pressure distribution, and a robot hand.

2. Related Art

As a current-driven actuator element, there has been known an ion-conducting polymeric actuator (also referred to as an ionic polymer metal composite (IPMC), anionic conducting polymer gel film (ICPF)) (see, e.g., JP-A-4-275078 (Document 1) and JP-A-11-169393 (Document 2)). The IPMC includes a joined object formed by bonding electrodes to both surfaces of an ion-conductive polymer (polyelectrolyte gel). When applying a voltage between the electrodes, cations migrate, and water molecules also migrate in accordance therewith, and thus, one of the surfaces expands, and the other contracts. Therefore, when applying the voltage, the IPMC bends. The IPMC has features such as high flexibility, light weight, silence, and easiness in miniaturization.

The IPMC can be used as a displacement sensor. JP-A-2013-148472 (Document 3) discloses the fact that an object woven with IPMC reeds in horizontal and vertical directions is used as a pressure sensor.

For the sensor having a configuration woven with actuator segments as described in Document 3, it is necessary to use a drive method suitable for the sensor.

### SUMMARY

An advantage of some aspects of the invention is to provide a technology of measuring a pressure distribution with the sensor having the configuration woven with the actuator segments.

An aspect of the invention provides a pressure distribution sensor including a sensor element having a plurality of current-driven actuator segments each having a first electrode and a second electrode arranged in a first direction and a second direction different from the first direction, and a corresponding number of sensing circuits to the number of the actuator segments, wherein the sensing circuits each include a first terminal electrically connected to the first electrode, a second terminal electrically connected to the second electrode, a third terminal to which an electrode selection signal for selecting one of the first electrode and the second electrode is input, a fourth terminal to which a segment selection signal for selecting the actuator segment out of the plurality of actuator segments, and a fifth terminal adapted to output a signal obtained via the electrode selected by the electrode selection signal from the electrodes of the actuator segment selected by the segment selection signal.

According to this pressure distribution sensor, the pressure distribution can be measured using the sensor element having the configuration woven with the actuator segments.

In the sensor element described above, the plurality of actuator segments may be crossed over and under each other alternately in the first direction and the second direction.

According to the pressure distribution sensor, the pressure distribution can be measured with the resolution corresponding to one actuator segment.

Another aspect of the invention provides a method of measuring a pressure distribution in the pressure distribution sensor including a sensor element having a plurality of current-driven actuator segments each having a first electrode and a second electrode arranged along a first direction and a second direction different from the first direction, the method including supplying an electrode selection signal adapted to select one of the first electrode and the second electrode in accordance with a way of crossing the plurality of actuator segments over and under each other in the sensor element, supplying a segment selection signal adapted to sequentially select some actuator segments from the plurality of actuator segments unit by unit along the first direction, and outputting a signal obtained via the electrode selected by the electrode selection signal from the electrodes of the actuator segment selected by the segment selection signal.

According to this method of measuring a pressure distribution, the pressure distribution can be measured using the sensor element having the configuration woven with the actuator segments.

The segment selection signal may include a period corresponding to one unit, in which the actuator segment is not selected, at the timing corresponding to the position where the side of the actuator segment, on which the actuator segment is crossed over or under another actuator segment, is changed in the first direction.

Still another aspect of the invention provides a robot hand including a sensor element having a plurality of current-driven actuator segments each having a first electrode and a second electrode arranged along a first direction and a second direction different from the first direction, and a corresponding number of sensing circuits to the number of the actuator segments, wherein the sensing circuits each include a first terminal electrically connected to the first electrode, a second terminal electrically connected to the second electrode, a third terminal to which an electrode selection signal for selecting one of the first electrode and the second electrode is input, a fourth terminal to which a segment selection signal for selecting the actuator segment out of the plurality of actuator segments, and a fifth terminal adapted to output a signal obtained via the electrode selected by the electrode selection signal from the electrodes of the actuator segment selected by the segment selection signal.

According to this robot hand, the control corresponding to the pressure distribution can be performed.

### BRIEF DESCRIPTION OF THE DRAWINGS

The invention will be described with reference to the accompanying drawings, wherein like numbers reference like elements.

FIG. 1 is a diagram showing an example of a configuration of a pressure distribution sensor 1 according to an embodiment of the invention.

FIG. 2 is a diagram showing a structure of an actuator segment 11.

FIGS. 3A and 33 are diagrams for explaining the operation principle of an IPMC actuator.

FIG. 4 is a perspective view showing a structure of a sensor element 10.

FIG. 5 is a diagram for explaining a circuit configuration of a sensing circuit 20.

FIG. 6 is a diagram showing an example of a contact point configuration between the actuator segments 11 and the sensing circuits 20.

FIG. 7 is a timing chart showing an operation of the pressure distribution sensor 1.

FIG. 8 is a diagram showing a robot hand 100 according to Modified Example 1.

### DESCRIPTION OF AN EXEMPLARY EMBODIMENT

### 1. Configuration

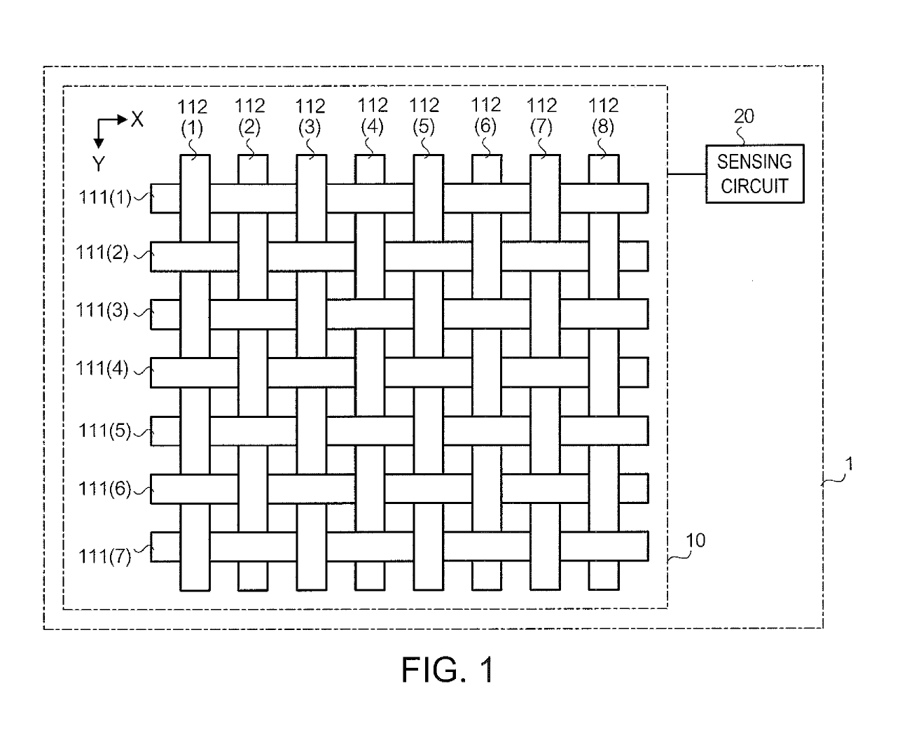

FIG. 1 is a diagram showing an example of a configuration of a pressure distribution sensor 1 according to an embodiment of the invention. The pressure distribution sensor 1 has a sensor element 10 and a sensing circuit 20. The pressure distribution sensor 1 is a device for measuring a pressure distribution using the sensor element 10. Details of the sensing circuit 20 will be described later.

The sensor element 10 has a plurality of actuator segments 11. In this example, the actuator segments 11 each have a shape (e.g., a reed-like shape) elongated in one direction. The actuator segments 11 are disposed along the vertical direction and the horizontal direction (specifically, crossed over and under each other). The horizontal direction in the sensor element 10 is defined as an X direction, and the vertical direction is defined as a Y direction. Hereinafter, for the sake of convenience of explanation, the actuator segments 11 having the longitudinal direction parallel to the X direction are each expressed as an actuator segment 111, and the actuator segments 11 having the longitudinal direction parallel to the Y direction are each expressed as an actuator segment 112. In this example, the sensor element 10 includes m actuator segments 111 and n actuator segments 112. It should be noted that in the case in which the direction is not particularly discriminated, the actuator segments are simply expressed as actuator segments 11.

Further, in the case of discriminating one of the actuator segment 111 from the rest of the actuator segments 111, the i^{th} actuator segment 111 from the top is expressed as the actuator segment 111(i). Similarly, the j^{th} actuator segment 112 from the left is expressed as the actuator segment 112(j).

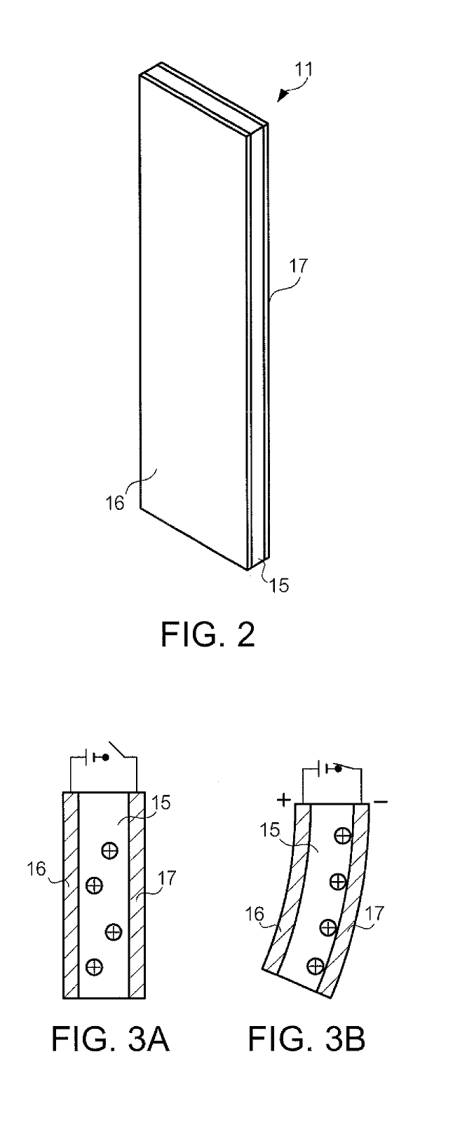

FIG. 2 is a diagram showing a structure of the actuator segment 11. The actuator segment 11 is a current-driven actuator, in particular in this example, an ion-conducting polymer (ionic polymer metal composite (IPMC)) actuator. The actuator segment 11 has an ion-exchange membrane 15, and a pair of electrodes 16, 17. As the ion-exchange membrane 15, either of a cation-exchange membrane and an anion-exchange membrane can be used. As the cation-exchange membrane, there is used, for example, a fluorine resin ion-exchange membrane having a sulphone group or a carboxyl group, or a polystyrene sulphonate membrane. As the electrodes 16, 17, there is used, for example, noble metal such as platinum, iridium, palladium, or ruthenium, conductive polymer, or black lead.

The IPMC is a material having elasticity like rubber to the touch, light in weight, and having such good workability as to be able to easily be cut with scissors.

FIGS. 3A and 3B are diagrams for explaining the operation principle of the IPMC actuator. When making the IPMC actuator operate, the ion-exchange membrane 15 is required to be in an moisture state. When applying a voltage between the electrode 16 (an anode) and the electrode 17 (cathode), the cations migrate toward the cathode. On this occasion, the water molecules also migrate in the ion-exchange membrane 15 toward the cathode in accordance with the migration of the cations. Due to the migration of the water molecules, there occurs a difference in water amount between the anode side and the cathode side. On this occasion, the part (the cathode side) high in water amount expands, while the part (the anode side) low in water amount contracts. Therefore, the ion-exchange membrane 15 bends toward the anode side.

Here, the bend of the IPMC actuator is caused by the migration of the ions, namely a current. The expression “current-driven” is attributed to this operation principle. It should be noted that if the migration of the ions stops (the current stops flowing) despite the voltage is applied, the difference in water amount is relaxed with time due to diffusion of the water molecules. Therefore, the bend of the ion-exchange membrane 15 is restored.

FIG. 1 is referred to again. The actuator segments 111 and the actuator segments 112 are crossed over and under each other alternately. In other words, regarding the intersections between the actuator segment 111(1) and the actuator segments 112, for example, the actuators 112 come to the upper side (obverse side) alternately every other segment. Specifically, in the intersection between the actuator segment 111(1) and the actuator segment 112(1), the actuator segment 112(1) comes to the upper side, while in the intersection between the actuator segment 111(1) and the actuator segment 112(2), the actuator segment 112(2) comes to the lower side. In a generalized expression, in the intersection between the actuator segment 111(2i−1) and the actuator segment 112(2j−1), the actuator segment 112(2j−1) comes to the upper side, while in the intersection between the actuator segment 111(2i−1) and the actuator segment 112(2j), the actuator segment 112(2j) comes to the lower side (i and j are each a natural number equal to or greater than 1).

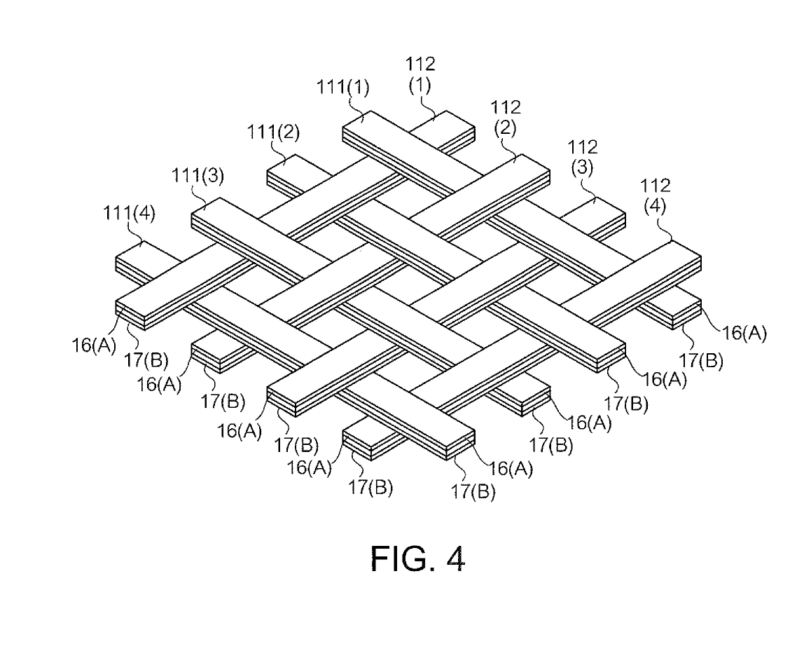

FIG. 4 is a perspective view showing a structure of the sensor element 10. The actuator segments 111 and the actuator segments 112 are crossed over and under each other in a direction in which the respective electrodes have contact with each other. Here, both of the actuator segments 111 and the actuator segments 112 have the electrodes 16 appearing on the same side. Specifically, in each of the actuator segments, the electrode 16 appears on the obverse side, and the electrode 17 appears on the reverse side. It should be noted that in the explanation below, the electrode 16 and the electrode 17 are respectively referred to as an electrode A and an electrode B in some cases.

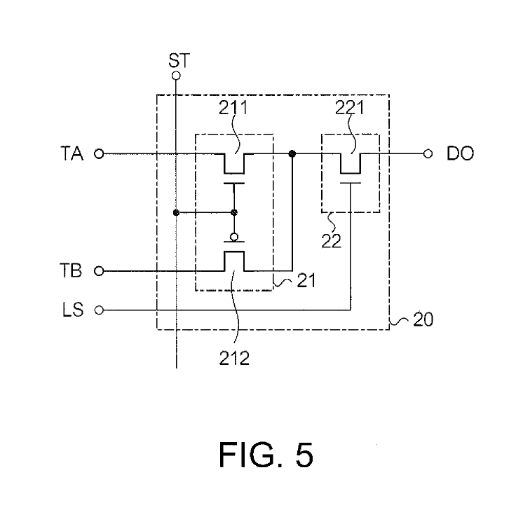

FIG. 5 is a diagram for explaining a circuit configuration of a sensing circuit 20. The sensing circuit 20 has a terminal TA, a terminal TB, a terminal ST, and a terminal LS as input terminals, and a terminal DO as an output terminal. Hereinafter, signals input to the respective terminals and a signal output from the terminal are denoted with the same reference symbols as those of the terminals. For example, the signal input to the terminal TA is denoted as signal TA.

The pressure distribution sensor 1 has the corresponding number of sensing circuits 20 to the number of the actuator segments 111 and the actuator segments 112. Specifically, the pressure distribution sensor 1 has the (m+n) sensing circuits 20.

Further, the sensing circuits 20 each have switches 21, 22. The switch 21 is a switch for selecting a signal to be output as an output signal DO among the signals TA, TB. In this example, the switch 21 includes FETs 211, 212. The FET 211 is an n-channel FET, and the FET 212 is a p-channel FET. The source of the FET 211 is connected to the electrode 16 of corresponding one of the actuator segments 11. The source of the FET 212 is connected to the electrode 17 of corresponding one of the actuator segments 11. The gate of each of the FETs 211, 212 is connected to a signal line ST. The signal line ST is a signal line to be supplied with a selection signal ST. The selection signal ST is a signal for selecting either one of the electrodes 16, 17. In the case in which the selection signal ST is in the high level, the FET 211 becomes in the low-impedance state, and the FET 212 becomes in the high-impedance state. In other words, the electrode 16 is selected. In the case in which the selection signal ST is in the low level, the FET 211 becomes in the high-impedance state, and the FET 212 becomes in the low-impedance state. In other words, the electrode 17 is selected.

The switch 22 is a switch for switching between output and non-output of a signal obtained via the electrode selected by the switch 21. In this example, the switch 22 includes an FET 221. The FET 221 is an n-channel FET. The source of the FET 221 is connected to the switch 21. The drain of the FET 221 is connected to the output terminal DO. The gate of the FET 221 is connected to a signal line LS. The signal line LS is a signal line to be supplied with a selection signal LS. The selection signal LS is a signal for selecting one actuator segment 11 out of the plurality of actuator segments 11. In the case in which the selection signal SL is in the high level, the FET 221 becomes in the low-impedance state, and the output of the switch 21 and the output terminal DO are electrically connected to each other. Therefore, the signal obtained via the electrode selected by the switch 21 is output. In the case in which the selection signal SL is in the low level, the FET 221 becomes in the high-impedance state, and the signal in the output terminal DO becomes indefinite.

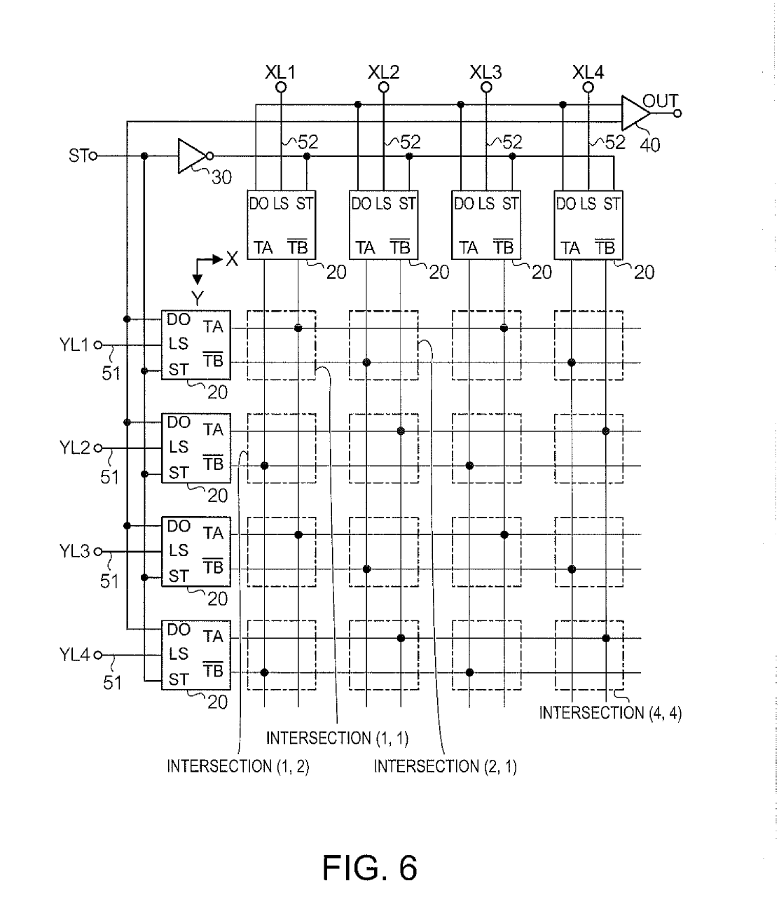

FIG. 6 is a diagram showing an example of a contact point configuration between the actuator segments 11 and the sensing circuits 20. The sensing circuits 20 and the actuator segments 11 correspond one-to-one to each other. Specifically, the pressure distribution sensor 1 includes m sensing circuits 20 corresponding to the m actuator segments 111 and n sensing circuits 20 corresponding to the n actuator segments 112, totally (m+n) sensing circuits 20. Hereinafter, for the sake of convenience of explanation, the intersection between the actuator segment 111(y) and the actuator segment 112(x) is expressed as an intersection (x, y).

The pressure distribution sensor 1 has m row selection lines 51 and n column selection lines 52. The row selection line 51 is a signal line to be supplied with a selection signal YLj. The selection signal YLj is a signal for sequentially and exclusively selecting one actuator segment 111 out of the plurality of actuator segments 111. To the terminals LS of the sensing circuits 20 corresponding to the actuator segments 111 out of the plurality of sensing circuits 20, there are connected the row selection lines 51, respectively. The selection signal XLi supplied to the column selection line 52 is a signal for sequentially and exclusively selecting one actuator segment 112 out of the plurality of actuator segments 112. To the terminals LS of the sensing circuits 20 corresponding to the actuator segments 112 out of the plurality of sensing circuits 20, there are connected the column selection lines 52, respectively.

In each of the intersections between the actuator segments 111 and the actuator segments 112, there exist the electrodes 16 and the electrodes 17 of the respective actuator segments, totally four electrodes. FIG. 6 shows which two of these four electrodes are connected to each other. For example, in the intersection (1, 1), the electrode 16 (the electrode A) of the actuator segment 111 and the electrode 17 (the electrode B) of the actuator segment 112 are connected to each other. In another example, in the intersection (2, 1), the electrode 17 (the electrode B) of the actuator segment 111 and the electrode 16 (the electrode A) of the actuator segment 112 are connected to each other.

The pressure distribution sensor 1 has an inverter 30. To the terminals ST of the sensing circuits 20 corresponding to the actuator segments 111 out of the plurality of sensing circuits 20, there is input the selection signal ST. To the terminals ST of the sensing circuits 20 corresponding to the actuator segments 111, there is input the selection signal ST having been inverted by the inverter 30.

The pressure distribution sensor 1 has a differential amplifier 40. The differential amplifier 40 is a circuit for amplifying a difference between the signals respectively input to the two input terminals, and then outputting the result from the output terminal. The output of the differential amplifier 40 corresponds to the output OUT of the pressure distribution sensor 1.

### 2. Operation

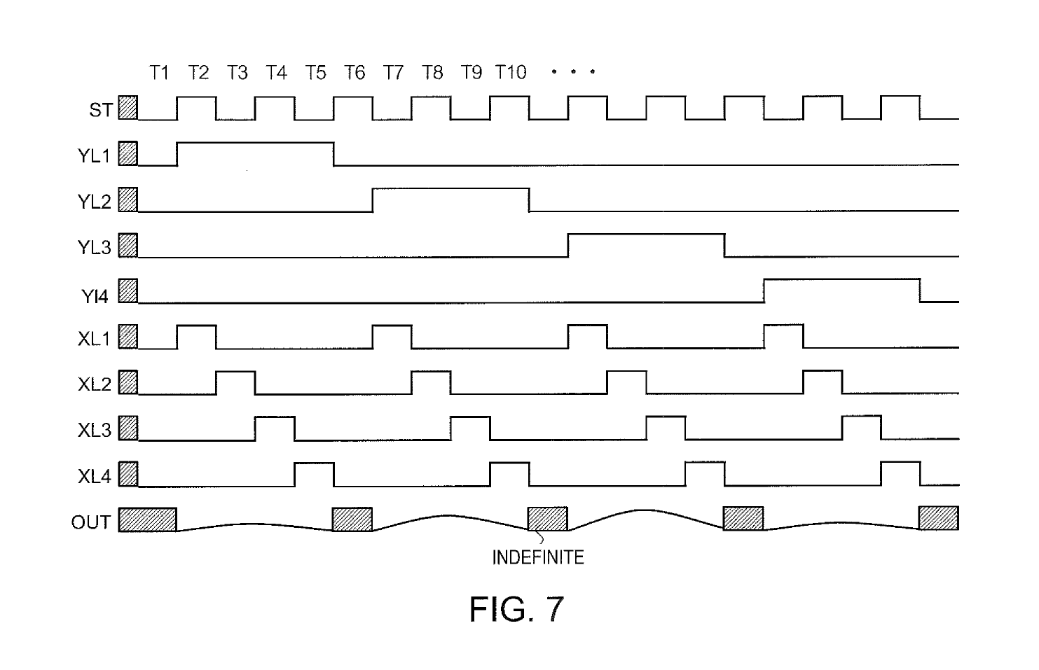

FIG. 7 is a timing chart showing an operation of the pressure distribution sensor 1 according to an embodiment of the invention. FIG. 7 shows an example of the selection signal ST, the selection signals YL1 through YL4, the selection signals XL1 through XL4, and the output signal OUT. In other words, in the present example, n=m=4 is fulfilled.

The selection signal ST is periodically switched to the high level and the low level. The cycle in which the level of the selection signal ST is switched corresponds to the basic operation cycle of the pressure distribution sensor 1, namely a unit period. Hereinafter, the k^{th} unit period is expressed as a period Tk.

The selection signal YLj is set to the high level for m cycles, namely a period corresponding to four cycles in the present example. An interval corresponding to one cycle is provided from when the selection signal YLj is switched from the high level to the low level to when the selection signal TLj+1 is switched from the low level to the high level. The selection signal YLj is sequentially and exclusively set to the high level.

The selection signal XLi is sequentially and exclusively set to the high level in the period in which the selection signal YLj is in the high level. For example, in the period in which the selection signal YL1 is in the high level, the selection signals XL1 through XL4 are sequentially and exclusively set to the high level by one cycle. In the period in which the selection signal YL2 is in the high level, the selection signals XL1 through XL4 are sequentially and exclusively set to the high level again by one cycle.

Now, the period T2 (ST: high, YL1: high, and XL1: high) is considered. Since the selection signal YL1 is in the high level, the sensor output is obtained from the output terminal DO of the sensing circuit 20 corresponding to the actuator segment 111(1). Since the selection signal ST is in the high level, the sensor output is a signal obtained via the electrode 16 (the electrode A) of the actuator segment 111(1). In the first row, the electrodes each having a contact point with the electrode 16 (the electrode A) of the actuator segment 111(1) are the electrodes 17 (the electrodes B) of the actuator segments 112(1), 112(3). In this case, since the selection signal XL1 is in the high level, and the selection signal XL3 is in the low level, the sensor output is not obtained from the actuator segment 112(3), but is obtained from the actuator segment 112(1). After all, in the period T2, the sensor output corresponding to the displacement of the actuator segment 111 and the actuator segment 112 at the intersection (1, 1) can be obtained. Similarly, in the period T3, the sensor output corresponding to the displacement of the actuator segment 111 and the actuator segment 112 at the intersection (2, 1) can be obtained. As described above, the sensor output at each of the intersections can be obtained in a time-sharing manner. Similarly to a typical video signal, the output signal has a structure in which the data at respective points of the matrix arranged in a time-series manner. Therefore, by using the processing technology of the video signal, the pressure distribution can be obtained.

It should be noted that the reason that the interval corresponding to one cycle is provided from when the selection signal YLj is switched from the high level to the low level to when the selection signal YLj+1 is switched from the low level to the high level is to arrange that the level of the selection signal ST is alternately set to the high level and the low level in the first period of the selection signal YLj and the selection signal YLj+1. This is caused by the fact that the actuator segments 111 and the actuator segments 112 are alternately crossed over and under each other one by one. Specifically, at the timing corresponding to the position at which whether the actuator segment 111 is located on the obverse side of the actuator segment 112 or the reverse side thereof is switched, the period in which the actuator segments 111 are not selected is included as much as one cycle. The output signal OUT becomes indefinite in the period from when the selection signal YLj is switched from the high level to the low level to when the selection signal TLj+1 is switched from the low level to the high level.

Although FIG. 7 shows an example of the signals for scanning each of the intersections of the sensor element 10 once, in the case of periodically or continuously obtain the output from the sensor element 10, the signals shown in FIG. 7 are used repeatedly.

As explained hereinabove, according to the present embodiment, the sensor output at each of the intersections of the sensor element can be obtained. In the sensor element 10, by overlapping the actuator segments 11 each other, the output current or the output voltage is increased. Therefore, the gain of the differential amplifier 40 can be lowered, and thus the power consumption can be reduced. Further, by alternately crossing the plurality of actuator segments 11 over and under each other in the vertical direction and the horizontal direction, the strength of the sensor element 10 can be improved.

### 3. Modified Examples

The invention is not limited to the embodiment described above, but can be put into practice with a variety of modifications. Hereinafter, some modified examples will be explained. It is also possible to use two or more of the modified examples described below in combination.

### 3-1. Modified Example 1

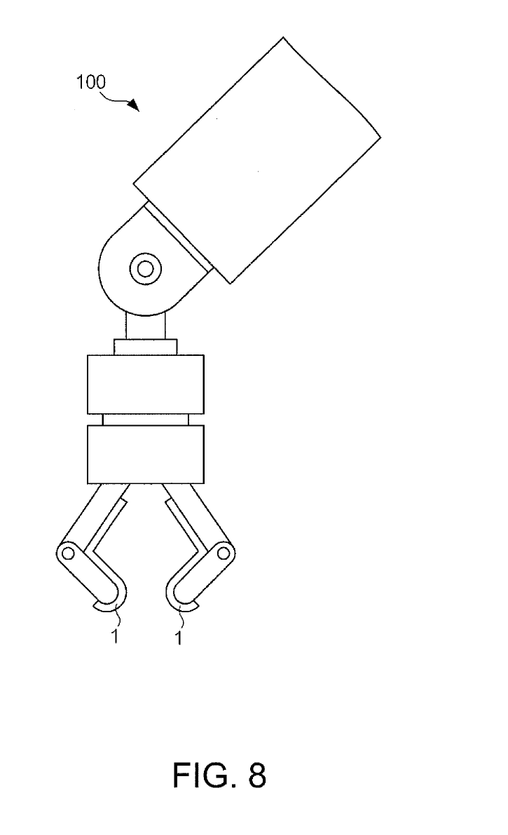

FIG. 8 is a diagram showing a robot hand 100 according to Modified Example 1. The robot hand 100 has the pressure distribution sensors 1 disposed in a hand part (a part for holding an object). The pressure (the force for clipping the object; grip force) in the hand part can be detected using the pressure distribution sensors 1. This detection result is used for the control of the robot hand 100. For example, it is possible to adjust the grip force in making the robot hand 100 hold a breakable object such as an egg, or a heavy iron ball. For example, when pouring water into a glass while making the robot hand 100 hold the glass, the weight of the glass varies. In this case, the grip force can be adjusted in accordance with the variation in the weight.

Further, the pressure distribution sensor 1 is thin and light in weight, and is therefore suitable for the robot hand 100. If the sensor is light in weight, the force acting on the arm decreases, and therefore, in the case of using the sensor for the arm having the same power, the lighter the sensor is, the heavier object can be gripped. Further, the total size of the robot hand 100 can be miniaturized.

Further, the pressure distribution sensor 1 is woven like a cloth, and is therefore soft and flexible. Therefore, the pressure distribution sensor 1 can also be applied to a field dealing with humans such as a nursing-care robot.

### 3-2. Modified Example 2

The way of crossing the actuator segments 11 over and under each other is not limited to what is explained in the description of the embodiment. For example, it is also possible for the actuator segments 111 and the actuator segments 112 to be crossed over and under each other alternately two by two. In this case, it is also possible for the sensing circuit 20 to be provided to every actuator segment 111, or to every two actuator segments 111. It should be noted that in the case of crossing the actuator segments 11 over and under each other alternately one by one as explained in the description of the embodiment, the pressure distribution can be measured with a resolution corresponding to one actuator segment 11.

### 3-3. Other Modified Examples

The actuator used for the actuator segment 11 is not limited to the IPMC actuator. An actuator other than the IPMC actuator such as an ion-gel actuator, a bucky-gel actuator, and a polymer actuator can also be used. It should be noted that the ion gel denotes a polyelectrolyte membrane having an ionic liquid confined in a macromolecular network structure. The Bucky gel denotes what is obtained by turning single-walled carbon nanotubes and an ionic liquid into a gel. In either of the cases, when providing electrodes to both surfaces of the gel membrane, and then applying a voltage, the gel membrane is displaced toward the anode. It should be noted that as the conductive polymer, there are used, for example, polyacetylene, polyaniline, polypyrrole, and polythiophene.

The switches 21, 22 are not limited to those described in the embodiment as an example. Switches other than those explained in the description of the embodiment can also be used.

What is claimed is:

1. A pressure distribution sensor comprising:
at least one first actuator segment disposed in a first direction;
at least one second actuator segment disposed in a second direction different from the first direction;
a first sensing circuit connected to the first actuator segment;
a second sensing circuit connected to the second actuator segment; and
a differential amplifier adapted to take an output of the first sensing circuit and an output of the second sensing circuit as inputs,
wherein the first actuator segment has a first electrode and a second electrode disposed so as to be opposed to the first electrode,
the second actuator segment has a third electrode and a fourth electrode disposed so as to be opposed to the third electrode, and
the first actuator segment and the second actuator segment are disposed so that one of a pair of the second electrode and the third electrode and a pair of the first electrode and the fourth electrode have contact with each other.

2. The pressure distribution sensor according to claim 1, wherein
one of an output of the first electrode and an output of the second electrode is selected and then output as the output of the first sensing circuit, and
one of an output of the third electrode and an output of the fourth electrode is selected and then output as the output of the second sensing circuit.

3. The pressure distribution sensor according to claim 1, wherein
a number of the first actuator segments and a number of the first sensing circuits are each larger than one,
a number of the second actuator segments and a number of the second sensing circuits are each larger than one, and
the inputs of the differential amplifier are the output of either one of the first sensing circuits and the output of either one of the second sensing circuits.

4. The pressure distribution sensor according to claim 3, wherein
the first actuator segments and the second actuator segments are alternately crossed over and under each other, and
the first actuator segment disposed next to the first actuator segment, which is crossed one of over and under the second actuator segment so that the second electrode and the third electrode have contact with each other, is crossed one of over and under the second actuator segment so that the first electrode has contact with the fourth electrode of the second actuator segment.

5. A method of measuring a pressure distribution using the pressure distribution sensor according to claim 4 in accordance with a way of crossing the first actuator segments and the second actuator segments over and under each other, the method comprising:
a first step of selecting a predetermined one of the first sensing circuits out of the first sensing circuits;
a second step of selecting a predetermined one of the second sensing circuits out of the second sensing circuits;
a third step of selecting either one of the output of the first electrode and the output of the second electrode in the predetermined first sensing circuit;
a fourth step of selecting either one of the output of the third electrode and the output of the fourth electrode in the predetermined second sensing circuit; and
a fifth step of calculating a pressure value in a part where the first actuator segment connected to the predetermined first sensing circuit and the second actuator segment connected to the predetermined second sensing circuit overlap each other.

6. The method of measuring a pressure distribution according to claim 5, wherein
in the selection of the electrodes in the third step and the fourth step, one of the first electrode and the second electrode of the first actuator segment and one of the third electrode and the fourth electrode of the second actuator segment failing to have contact with each other in the part where the first actuator segment and the second actuator segment overlap each other are selected.

7. The method of measuring a pressure distribution according to claim 5, wherein
the first step through the fourth step are performed so as to scan the parts where the first actuator segment and the second actuator segment overlap each other.

8. A robot hand comprising:
the pressure distribution sensor according to claim 1.
